(19) United States
(12) Patent Application Publication
(10) Pub. No.: US 2010/0185720 A1
(43) Pub. Date: Jul. 22, 2010

(54) POPULARIZATION SYSTEM AND METHOD FOR INFORMATION TRANSMISSION USING DESKTOP

(76) Inventor: Suk-Ho Ryu, Seoul (KR)

Correspondence Address: PARK LAW FIRM, 3255 WILSHIRE BLVD, SUITE 1110, LOS ANGELES, CA, 90010, US

(21) Appl. No.: 11/909,695

(22) PCT Filed: Mar. 15, 2006
(86) PCT No.: PCT/KR06/00939

§ 371 Date: Sep. 25, 2007

(30) Foreign Application Priority Data
Apr. 1, 2005 (KR) 10-2005-0027468

(51) Int. Cl. G06F 15/16

(52) U.S. Cl. 709/203

(57) ABSTRACT

A popularization system and method for information transmission using a desktop is provided. The popularization system comprises a manager server in which member information about users who have applied for admission, information about channels which the members have registered, contents information registered by the members and skin information used to display contents are stored, so as to perform channel registration and contents transmission, and a user computer which transmits and receives a variety of information through the manager server and a communication network, stores selected channel, received contents, and skins related to the contents and in which a client module for displaying the skin and contents on the user computer is mounted, wherein the user computer prepares to transmit information to receivers who have a user computer in which a client module for popularization of information transmission using the desktop is mounted, and provided information can be received to an information receiver. Another online information communication unit for transmitting information directly onto a desktop subsequent to a web browser or email can be provided.

### TECHNICAL FIELD

The present invention relates to a popularization system and method for information transmission using a desktop, and more particularly, to a popularization system and method for information transmission using a desktop in which an apparatus and a method for registering an information transmission channel and information are provided to an information transmitter and an apparatus and a method for searching and selecting a previously-registered information transmission channel and continuously receiving information on a desktop through the selected channel are provided to an information receiver.

### BACKGROUND ART

Conventionally, a representative method of transmitting and receiving information by forming a channel through a communication network includes a method of reading a homepage through a web browser or a method of transmitting and receiving information via email. In the method of reading a homepage through a web browser, a complicated process of creating a homepage or a web site should be performed and endeavors for informing information receivers of the established homepage or web site should be made accordingly. An information transmitter must wait for an information receiver's visit after registering information on own homepage. Thus, this method can be regarded as a passive information transmission channel.

The method of transmitting and receiving information via email can be used as an active information transmission channel. However, a process of collecting and managing information receivers' email addresses is needed and endeavors for informing information receivers of an explanation of an information channel should also be made accordingly. Thus, in the two methods, it is not easy for users to establish an information transmission channel.

### DISCLOSURE OF THE INVENTION

The present invention provides a popularization system and method for information transmission using a desktop in which another online information communication unit for directly transmitting information onto the desktop together with a web browser or email can be provided.

According to an aspect of the present invention, there is provided a popularization system for information transmission using a desktop, the popularization system comprising: a manager server in which member information about users who have applied for admission, information about channels which the members have registered, contents information registered by the members and skin information used to display contents are stored, so as to perform channel registration and contents transmission; and a user computer which transmits and receives a variety of information to/from the manager server through a communication network, stores selected channel, received contents, and skins related to the contents and in which a client module for displaying the skin and contents on the user computer is mounted, wherein the manager server prepares to transmit information to receivers who have a user computer in which a client module for popularization of information transmission using the desktop is mounted, and provided information can be received to an information receiver.

According to another aspect of the present invention, there is provided a popularization method for information transmission using a desktop, the popularization method comprising: applying for admission, registering a channel and registering information on each channel so that transmission of information to a receiver is prepared; and installing a client module in a user computer, selecting an information transmission channel, receiving information transmitted to the channel and displaying the received information on the user computer so that an information receiver receives information provided from the manager server.

The registering of the channel may be used only by a user who has applied for admission, in the registering of the channel, one member may generate several channels, the user selects an upper category and a lower category needed in searching channels and inputs a channel search keyword needed in searching keywords, the channel may be classified into an open channel and a closed channel, when the channel is not open to the public, the password is needed in reception setting through the manager server or the client module, only when a password input by the user is identical with a channel password, reception of the channel may be set, and a channel name or a logo of a channel may be displayed in the skin to be displayed together with contents.

The registering of information on each channel may be used only by a member who has registered the channel, in the registering of the information on each channel, a channel on which information or contents is to be registered is selected from channels which a member self has registered, the title and description of contents are input, a skin to be displayed together with contents is selected and a transmission period is input, the input contents may be displayed to users who have set reception of a corresponding channel, and if the users have set reception of the corresponding channel after the transmission period elapses or if the user computer is not turned on, corresponding contents are not displayed to the users.

The installing of the client module in the user computer may be simultaneously with selecting an information transmission channel, using one of a method through channel search, a method through tag insertion and a method through installation URL.

The displaying of the received information on the user computer may comprise combining skin, contents, and advertisement etc. and displaying a combination thereof on a screen of the user computer, in the displaying of the received information on the user computer, when the user receives new information, the information may be displayed on the lowermost end of all working windows of the desktop of the user computer so that a user's work may not be disturbed, and when the user wants to check past information, the user may select desired contents from the list of received contents of the user computer and may check them.

### BRIEF DESCRIPTION OF THE DRAWINGS

FIG. 1 is a schematic diagram of a popularization system for information transmission using a desktop according to an embodiment of the present invention;

FIG. 2 is a detailed diagram of types and attributes of information stored in a manager server;

FIG. 3 shows a screen displayed in an operation of applying for admission;

FIG. 4 shows a screen displayed in an operation of registering a channel;

FIG. 5 shows a screen showing a list of channels that members have registered;

FIG. 6 shows a screen displayed in an operation of registering contents;

FIG. 7 shows a screen showing a list of contents that members have registered;

FIG. 8 shows a screen on which channel search and reception setting are shown in an operation of selecting an information transmission channel;

FIG. 9 shows a channel reception agreement screen displayed when a user sets reception of a predetermined channel;

FIG. 10 shows a channel list and channel setting in an operation of selecting an information transmission channel;

FIG. 11 shows a screen showing a list of received contents in an operation of receiving information transmitted to a channel; and

FIGS. 12 and 13 show screens on which skin and contents are combined in an operation of displaying received information on a user computer.

### BEST MODE FOR CARRYING OUT THE INVENTION

Hereinafter, embodiments of the present invention will be described in detail with reference to the attached drawings.

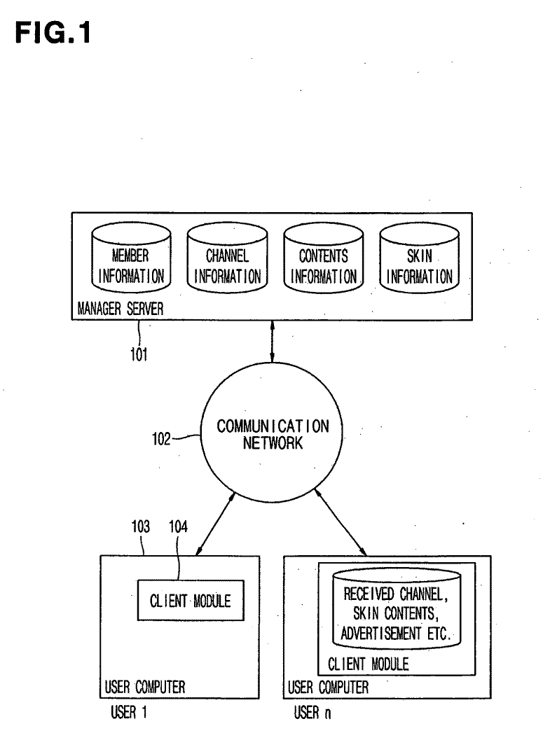

Referring to FIG. 1, a popularization system for information transmission using a desktop according to the present invention includes a manager server 101 in which member information, channel information, contents information and skin information are stored, and a user computer 103 which transmits and receives information from the manager server 101 through a communication network 102, stores reception-set channel information, received contents information and skin information for displaying contents and in which a client module 104 for displaying the contents on a screen of the user computer 103 together with the skin is mounted.

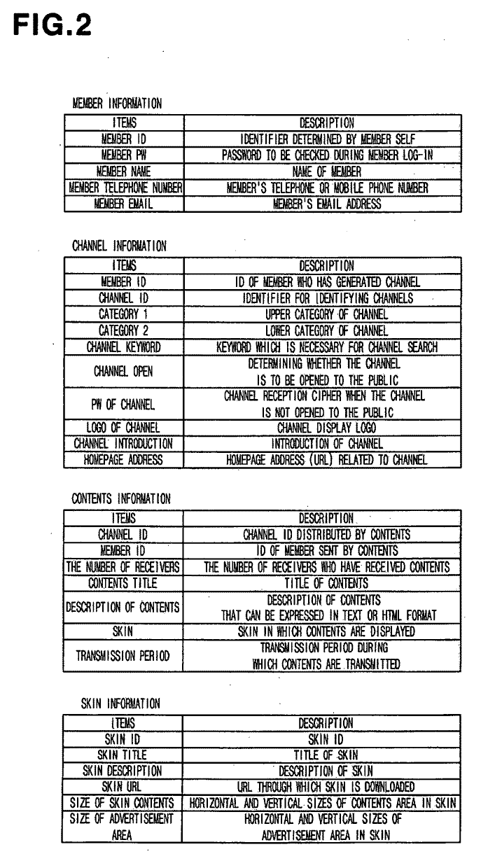

Referring to FIG. 2, member information to be stored in the manager server 101 includes a member ID which is an identifier determined by a member self, a member password (PW) to be checked during member log-in, a member name, a member telephone number which is a member's telephone or mobile phone number, and a member email which is a member's email address, etc.

In addition, channel information to be stored in the manager server 101 includes a member ID of a member who has generated a channel, a channel ID which is an identifier for identifying channels, category 1 which is an upper category of a channel, category 2 which is a lower category of the channel, a channel keyword which is necessary for channel search, channel open to determine whether the channel is to be opened to the public, a password (PW) of a channel which is a channel reception cipher when the channel is not opened to the public, a logo of a channel, channel introduction, and a homepage address related to a channel.

In addition, contents information to be stored in the manager server 101 includes a channel ID distributed by contents, a member ID sent by contents, the number of receivers who have received contents, the title of contents, the description of contents that can be expressed in an TEXT or HTML format, skin in which contents are displayed, and a transmission period during which contents are transmitted, etc.

Last, skin information to be stored in the manager server 101 includes a skin ID, a skin title, a skin description, skin URL through which skin is downloaded, the size of skin contents that indicates horizontal and vertical sizes of a contents area in the skin, and the size of an advertisement area that indicates horizontal and vertical sizes of an advertisement area in the skin, etc.

In addition, in the popularization method for information transmission using a desktop according to the present invention, a user who is an information transmitter, performs operations of applying for admission, registering a channel, and registering information on each channel. In addition, a user who is an information receiver, performs operations of installing a provided client module, that is, an information transmission device, in a user computer, selecting an information transmission channel, receiving information transmitted to a channel, and displaying the received information on the user computer.

Each of the operations to be performed by the information transmitter and the information receiver will now be described in greater detail.

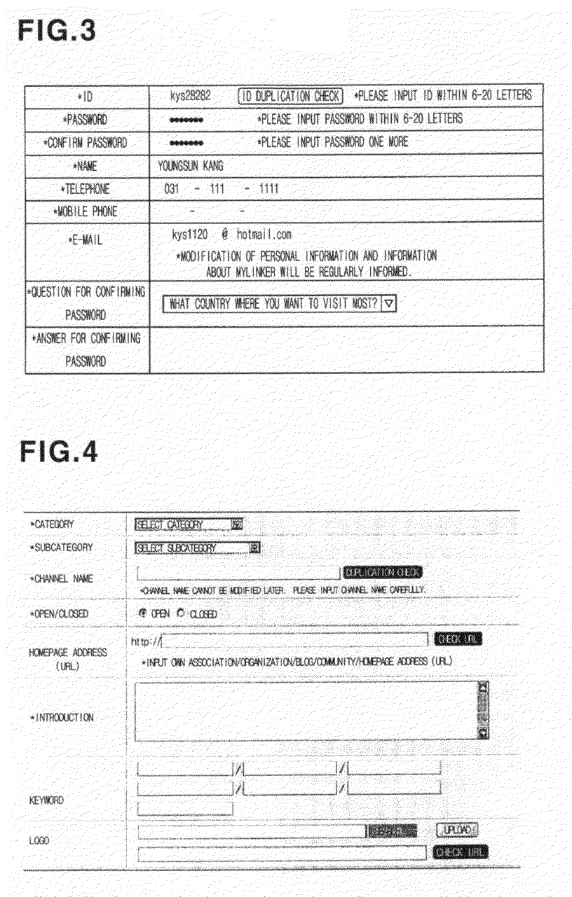

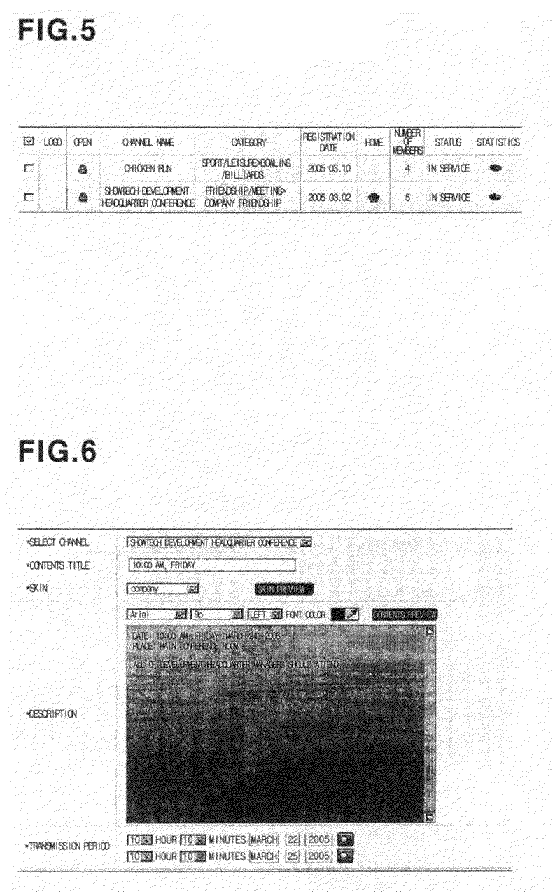

First, in the operation of applying for admission, a user who wants to transmit information onto a desktop using the manager server 101 applies for admission. As illustrated in FIG. 3, minimum personal information by which users can be identified is input. If the operation of applying for admission is performed, the user qualifies to register a channel and contents. Next, the operation of registering a channel can be performed by only the user who has applied for admission. As illustrated in FIG. 4, one member can generate several channels. The user must select an upper category and a lower category needed in searching channels and must input a channel search keyword needed in searching keywords. In addition, the channel can be classified into an open channel and a closed channel. The open channel is a channel of which reception can be set by anybody, and the closed channel is a channel of which reception can be set only by inputting a password. When the channel is not open to the public, the password is needed in reception setting through the manager server 101 or the client module 104. Only when a password input by the user is identical with a channel password, reception of the channel can be set. A channel name or a logo of a channel can be displayed in the skin to be displayed together with contents. Of course, the list of channels registered as illustrated in FIG. 5 can also be checked on a screen.

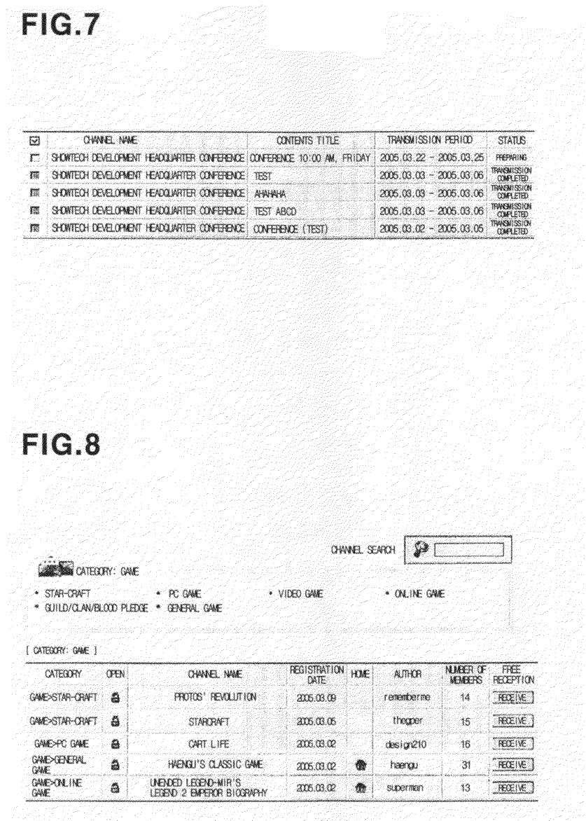

In addition, the operation of registering information on each channel is an operation that can be used by a member who has registered a channel. As illustrated in FIG. 6, a channel on which information or contents is to be registered should be selected from channels which a member self has registered, should input the title and description of contents, should select a skin to be displayed together with contents and should input a transmission period. The input contents can be displayed to users who have set reception of a corresponding channel. If the users have set reception of the corresponding channel after the transmission period elapses or if the user computer 103 is not turned on, corresponding contents are not displayed to the users. Of course, registered contents as in the channel can also be checked on the screen, as illustrated in FIG. 7.

The operation of installing the client module 104 provided by the manager server 101 in the user computer 103 is performed simultaneously with selecting an information transmission channel, using the following three methods. Here, in the second and third methods, channel registration is informed a channel registrant using a means such as email in the operation of registering a channel. When the client module 104 has been already installed in the user computer 103, only reception of a corresponding channel is set.

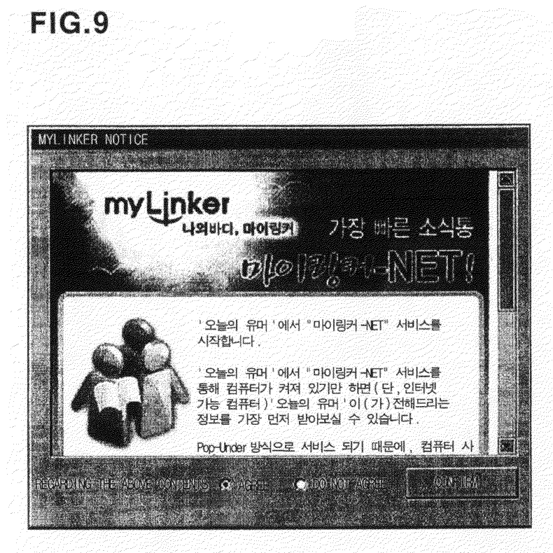

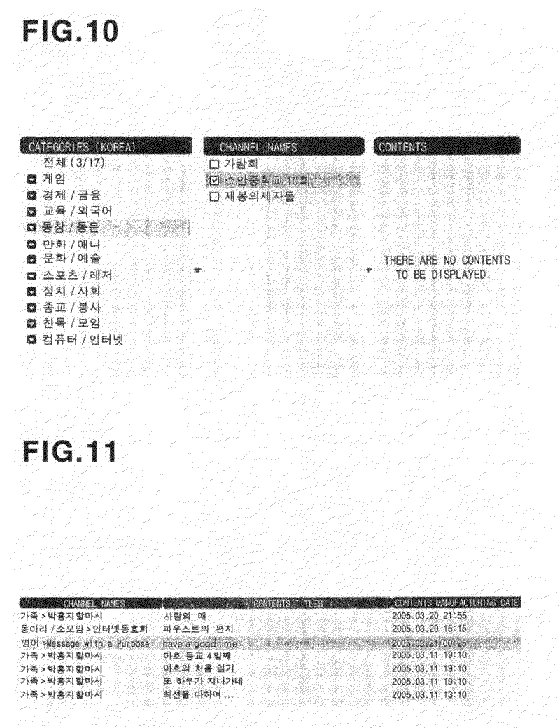

First, in the first method through channel search, as illustrated in FIGS. 8 through 10, a corresponding channel is selected through a web page of the manager server 101 or through channel search of the client module 104. If a ‘receive’ button of the corresponding channel is pressed, a channel reception agreement screen is displayed. If a user presses only ‘agree’, the client module 104 can be simply installed.

In the second method through tag insertion, installation and channel reception setting can be performed if the user contacts own homepage, only by inserting proper ‘JavaScript tag’ directly on </body> of a homepage HTML source. JavaScript tag for installation has the following format: <script language=“javaScript” src=“http://mylinkernet.contents.mylinker.co.kr/mylinkernet/health/DTSF_myli nker_NET10151_{—}118_DIRECT.js”></script>.

Corresponding ‘JavaScript’ is automatically generated during channel registration and is stored in the manager server 101 and is informed a channel registrant using a means such as email. When the user visits a member's homepage, a channel reception agreement screen is displayed. If the user presses only ‘agree’, the client module 104 can be simply installed.

Last, in the third method through installation URL, the following installation URL is informed through email, a notice board, and a messenger etc. When the user only clicks the installation URL, a channel guide screen and a channel reception agreement screen are displayed as a separate window. If the user presses only ‘agree’, the client module 104 can be simply installed.

http://mylinkernet.contents.mylinker.co.kr/mylinkernet/health/DTSF_mylin ker_NET10151_{—}118_install_home.html

The operation of receiving information transmitted to the selected channel using the above methods is performed in the user computer 103 in which the client module 104 is installed. The client module 104 contacts the manager server 101 and receives information such as skin transmitted to a channel of which reception is set, contents, and advertisement etc.

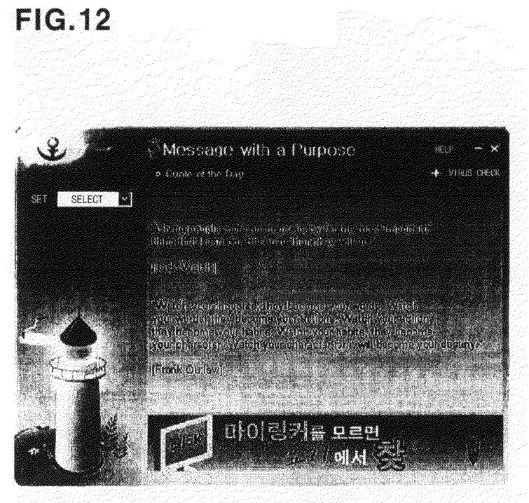

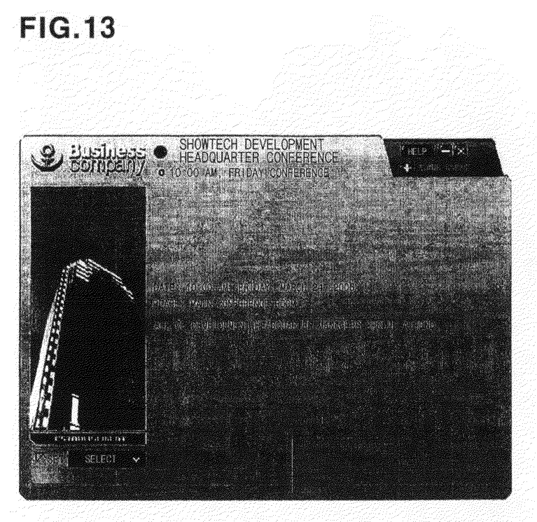

The operation of displaying the received information on the user computer 103 using a desktop is an operation of combining skin, contents, and advertisement etc. and displaying a combination thereof on a screen of the user computer 103, as illustrated in FIGS. 12 and 13. When the user receives new information, the information can be displayed on the lowermost end of all working windows of the desktop of the user computer 103 so that a user's work cannot be disturbed. When the user wants to check past information, the user can select desired contents from the list of received contents stored in the user computer 103 and check them.

### INDUSTRIAL APPLICABILITY

As described above, according to the present invention, a user can freely generate a channel through a simple operation of applying for admission and can simply register contents through the channel and can transmit information to information receivers and simultaneously, the information receivers can easily install a client module and set reception of a channel at the same time so that another online information communication unit for transmitting information directly onto a desktop subsequent to a web browser or email can be provided.

What is claimed is:

1. A popularization system for information transmission using a desktop, the popularization system comprising:
a manager server in which member information about users who have applied for admission, information about channels which the members have registered, contents information registered by the members and skin information used to display contents are stored, so as to perform channel registration and contents transmission; and
a user computer which transmits and receives a variety of information to/from the manager server through a communication network, stores selected channel, received contents, and skins related to the contents and in which a client module for displaying the skin and contents on the user computer is mounted,
wherein the manager server prepares to transmit information to receivers who have a user computer in which a client module for popularization of information transmission using the desktop is mounted, and provided information can be received to an information receiver.

2. A popularization method for information transmission using a desktop, the popularization method comprising:
applying for admission, registering a channel and registering information on each channel so that transmission of information to a receiver is prepared; and
installing a client module in a user computer, selecting an information transmission channel, receiving information transmitted to the channel and displaying the received information on the user computer so that an information receiver receives information provided from the manager server.

3. The popularization method of claim 2, wherein the registering of the channel can be used only by a user who has applied for admission, in the registering of the channel, one member can generate several channels, the user selects an upper category and a lower category needed in searching channels and inputs a channel search keyword needed in searching keywords, the channel can be classified into an open channel and a closed channel, when the channel is not open to the public, the password is needed in reception setting through the manager server or the client module, only when a password input by the user is identical with a channel password, reception of the channel can be set, and a channel name or a logo of a channel can be displayed in the skin to be displayed together with contents.

4. The popularization method of claim 2, wherein the registering of information on each channel can be used only by a member who has registered the channel, in the registering of the information on each channel, a channel on which information or contents is to be registered is selected from channels which a member self has registered, the title and description of contents are input, a skin to be displayed together with contents is selected and a transmission period is input, the input contents can be displayed to users who have set reception of a corresponding channel, and if the users have set reception of the corresponding channel after the transmission period elapses or if the user computer is not turned on, corresponding contents are not displayed to the users.

5. The popularization method of claim 2, wherein the installing of the client module in the user computer is simultaneously with selecting an information transmission channel, using one of a method through channel search, a method through tag insertion and a method through installation URL.

6. The popularization method of claim 2, wherein the displaying of the received information on the user computer comprises combining skin, contents, and advertisement etc. and displaying a combination thereof on a screen of the user computer, in the displaying of the received information on the user computer, when the user receives new information, the information can be displayed on the lowermost end of all working windows of the desktop of the user computer so that a user's work cannot be disturbed, and when the user wants to check past information, the user can select desired contents from the list of received contents of the user computer and can check them.
